(19) United States
(12) Patent Application Publication
(10) Pub. No.: US 2012/0307773 A1
(43) Pub. Date: Dec. 6, 2012

(54) Scheduling Request and ACK/NACK Simultaneous Transmission/Prioritization Over PUCCH in LTE

(75) Inventors: Esa Tapani Tiirola, Kempele (FI); Kari Pekka Pajukoski, Oulu (FI); Kari Juhani Hooli, Oulu (FI)

(73) Assignee: NOKIA SIEMENS NETWORKS OY, Espoo (FI)

(21) Appl. No.: 13/577,957

(22) PCT Filed: Feb. 12, 2010
(86) PCT No.: PCT/EP2010/051794

§ 371 Date: Aug. 16, 2012

(51) Int. Cl. H04W 72/12

(52) U.S. Cl. 370/329

(57) ABSTRACT

The invention is related to an apparatus including at least one processor and at least one memory including a computer program code, the at least one memory and the computer program code configured to, with the at least one processor, cause the apparatus at least to: prioritize either a positive or negative acknowledgement transmission or a scheduling request information transmission, or generate a simultaneous transmission of said transmissions for separate resources, and/or overbook a physical uplink control channel by extending scheduling request configuration signaling, and/or randomizing a physical uplink control channel resource.

### FIELD

The invention relates to apparatuses, a method, computer program, computer program product embodied on a computer readable medium and computer-readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

The evolvement of communications technologies, launching of different services attainable wirelessly, generally speaking a requirement for increased data rates, has lead to need to develop also the communication standards. One of the standards providing higher data rates is third generation partnership project (3GPP) long-term evolution (LTE) and 3GPP long-term evolution advanced (LTE-A).

One target of the development of the LTE-A standard is to reach requirements defined in International Mobile telecommunications Advanced (IMT-A). These include enhancement in performance, such as higher data rates compared to LTE, for example.

One issue to deal with is latency control. Also overhead limitations are under consideration.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: prioritize either a positive/negative acknowledgement transmission or a scheduling request information transmission, or generate a simultaneous transmission of said transmissions for separate resources, and/or overbook a physical uplink control channel by extending scheduling request configuration signaling, and/or randomizing a physical uplink control channel resource. According to another aspect of the present invention, there is provided a method comprising: prioritizing either a positive/negative acknowledgement transmission or a scheduling request information transmission, or generating a simultaneous transmission of said transmissions for separate resources, and/or overbooking a physical uplink control channel by extending scheduling request configuration signaling, and/or randomizing a physical uplink control channel resource.

According to yet another aspect of the present invention, there is provided an apparatus comprising: means for prioritizing either a positive/negative acknowledgement transmission or a scheduling request information transmission, or generating a simultaneous transmission of said transmissions for separate resources; and/or means for overbooking a physical uplink control channel by extending scheduling request configuration signaling; and/or means for randomizing a physical uplink control channel resource.

According to yet another aspect of the present invention, there is provided a computer program product embodied on a computer readable medium, the computer program being configured to control a processor to perform: prioritizing either a positive/negative acknowledgement transmission or a scheduling request information transmission, or generating a simultaneous transmission of said transmissions for separate resources, and/or overbooking a physical uplink control channel by extending scheduling request configuration signaling, and/or randomizing a physical uplink control channel resource.

According to yet another aspect of the present invention, there is provided a computer-readable medium encoded with instructions that, when executed by a computer, perform: prioritizing either a positive/negative acknowledgement transmission or a scheduling request information transmission, or generating a simultaneous transmission of said transmissions for separate resources, and/or overbooking a physical uplink control channel by extending scheduling request configuration signaling, and/or randomizing a physical uplink control channel resource.

### LIST OF DRAWINGS

Embodiments of the present invention are described below, by way of example only, with reference to the accompanying drawings, in which

FIG. 1 illustrates an example of a communications system;

FIG. 2 is a flow chart; and

FIG. 3 illustrates an example of an apparatus.

### DESCRIPTION OF EMBODIMENTS

The following embodiments to be described are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. The following embodiments to be described are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. The embodiments will be described with reference to the accompanying drawings, in which some, but not all embodiments of the invention are shown. Indeed, the invention may be embodied in many different forms and should not be construed as limited to the embodiments set forth herein.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however.

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a NodeB needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the NodeB.

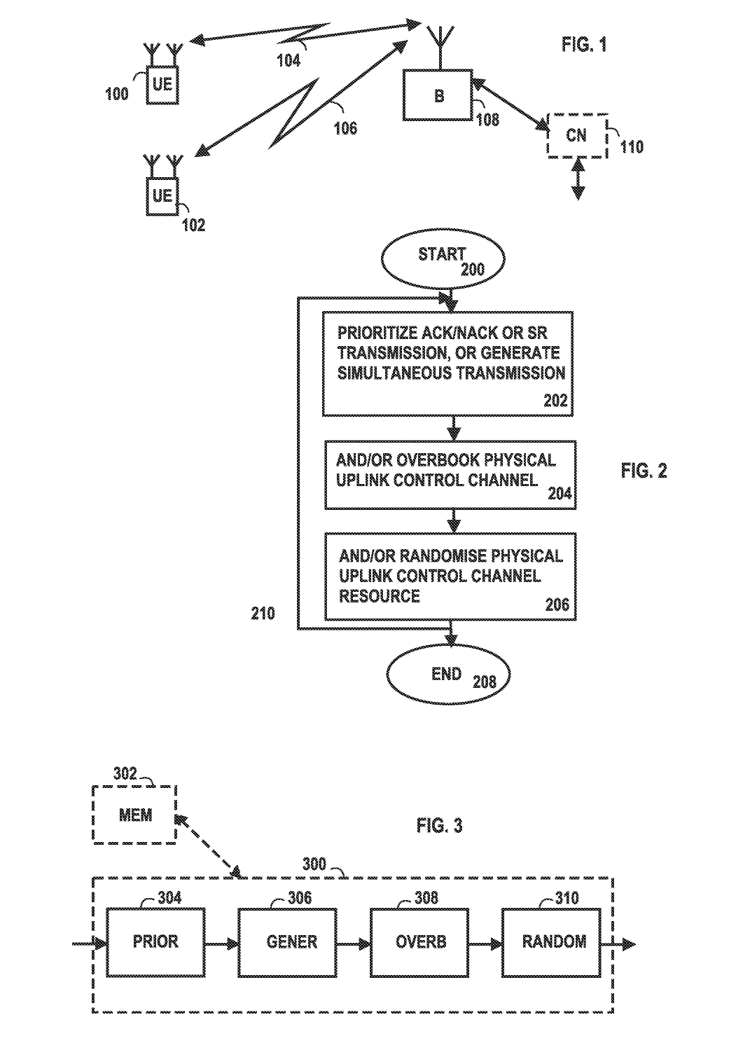

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1. The embodiments are not, however, restricted to the system given as an example but a person skilled in the art may apply the solution to other communication systems provided with the necessary properties.

FIG. 1 shows a part of a radio access network of E-UTRA, LTE or LTE-Advanced (LTE-A). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a NodeB 108 providing the cell. The physical link from a user device to a NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The NodeB may also be referred to a base station, an access point or any other type of interfacing device including a relay station capable of operating in a wireless environment.

The NodeB includes transceivers, for instance. From the transceivers of the NodeB, a connection is provided to an antenna unit that establishes bi-directional radio links to the user devices. The NodeB is further connected to a core network 110 (CN). Depending on the system, the counterpart on the CN side can be a serving system architecture evolution (SAE) gateway (routing and forwarding user data packets), packet data network gateway (PDN GW), for providing connectivity to user devices (UEs) to external packet data networks, or mobile management entity (MME), etc.

The communication system is also able to communicate with other networks, such as a public switched telephone network or the Internet.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device.

The user device (or a layer 3 relay node) is configured to perform one or more of user equipment functionalities described below with an embodiment, and it may be configured to perform functionalities from different embodiments. The user device may also be called a subscriber unit, mobile station, remote terminal, access terminal, user terminal or user equipment (UE) just to mention but a few names or apparatuses.

It should be understood that, in the FIG. 1, user devices are depicted to include 2 antennas only for the sake of clarity. The number of reception and/or transmission antennas may naturally vary according to a current implementation.

It is obvious for a person skilled in the art that the depicted system is only an example of a part of a radio access system and in practise, the system may comprise a plurality of NodeBs, the user device may have an access to a plurality of radio cells and the system may comprise also other apparatuses, such as physical layer relay nodes or other network elements.

Further, although the apparatuses have been depicted as single entities, different units, processors and/or memory units (not all shown in FIG. 1) may be implemented.

The LTE and LTE-Advanced (LTE-A) systems usually utilize various multiple input-multiple output (MIMO) technologies including transmission diversity, single user (SU)-MIMO, multiuser (MU)-MIMO, closed-loop precoding, and dedicated beamforming.

In the LTE or LTE-A uplink, non-data associated control signalling is transmitted on a physical uplink control channel (PUCCH) located on the edges of system bandwidth. Another option is to transmit uplink control signals on a physical uplink shared channel (PUSCH) multiplexed with uplink data.

Uplink signalling includes, for example, sending a scheduling request. A scheduling request (SR) is used to indicate that a user device is searching for a possibility to transmit data to a network. Typically a user device indicates a need for an uplink resource by transmitting a scheduling request indicator on PUCCH channel. One requirement for a scheduling request is that it should be suitable for a high enough number of simultaneous SR transmissions from user devices to NodeB:s while keeping system overhead caused by the SR transmissions small enough. It is beneficial for a system throughput to minimize the system overhead. The system overhead may be decreased for example by reducing the size of physical control channels, reference signal density, and/or cyclic prefix length. Another option which may be implemented in higher layers is header compression or other means reducing the amount of control signalling.

Improvements for dormant to active transition have been discussed during 3GPP release 10 study item phase and a shorter scheduling request (SR) cycle has been proposed as an option (TS 36.192 (v 9.0.0). The shorter cycle would reduce the average waiting time for a synchronized user device to request resources in a connected mode and thus producing latency reduction. However, a drawback with shorter scheduling request cycle is that it requires more resources of a physical uplink control channel (PUCCH) in a cell and thus deteriorates system capacity. This is natural due to increase in resource needs.

The scheduling request overhead problem is even more important in the case of SU-MIMO using open-loop transmission diversity, namely spatial orthogonal-resource transmission diversity (SORTD). Utilization of SORTD doubles the scheduling request (SR) overhead comparing to case without SORTD.

Further, both persistent and dynamic parts of PUCCH utilize common PUCCH channelization by using the same configuration parameter delta_shift that defines the cyclic shift separation between adjacent PUCCH resources. In quite a common case, the delta_shift value needs to be set on the basis of requirements set for a positive/negative acknowledgement (ACK/NACK) signalling corresponding to dynamically scheduled physical downlink shared channel (PDSCH). As a result of this, only 18 or 12 out of 36 scheduling request resources per a physical resource block (PRB) is supportable.

In the following, an embodiment of a method for improving scheduling request capacity is explained in further detail. The embodiment starts in block 200.

In block 202, either a positive acknowledgement (ACK) or negative acknowledgement (NACK) transmission or a scheduling request information transmission is prioritized, or a simultaneous transmission of said transmissions is generated for separate resources.

As an example for prioritizing, a hybrid automatic repeat request (HARQ)-ACK/NACK message and a scheduling request using PUCCH format 1a or 1b, and enhanced scheduling request format providing enhanced SR capacity (for example a scheduling request using enhanced scheduling request transmission) are made as alternatives to each other. This produces two signaling options for a scheduling request as shown below in Table 1:

TABLE 1

| | SR + ACK/NACK | Enhanced SR |
|---|---|---|
| Option 1 | Yes | No |
| Option 2 | No | Yes |

Enhanced scheduling request transmission may be implemented by using the principle of additional cover code presented in WO 2009/021952. Shortly, in WO 2009/021952, two block spread symbol sequences carrying SR (Sequence 1 and Sequence 2) are modulated by an additional cover code sequence [1, 1] or [1, −1]. This operation doubles the multiplexing capacity of the SR compared to the case w/o use of additional cover code sequence. When enhanced scheduling request transmission is used, either ACK/NACK transmission or scheduling request transmission may be prioritized.

For prioritizing an ACK/NACK transmission, it is assumed that an eNB (eNodeB) needs to transmit downlink data on Physical downlink shared channel (PDSCH). The eNB would then allocate PDSCH in such a manner that a corresponding ACK/NACK message would collide with a positive or negative scheduling request. This could effect a risk to at least temporarily loose the option to transmit a scheduling request. Another option is that the eNB allocates PUSCH resources to a user device, in which case an ACK/NACK message is transmitted via PUSCH and multiplexed with uplink data. A buffer status report including information on a scheduling request instead of a scheduling request message itself may be signaled.

In the case of a prioritized ACK/NACK transmission, user device operation may be as follows:

If (positive SR)

transmit ACK/NACK only
drop SR

else (negative SR)

transmit ACK/NACK only

end

For prioritizing a scheduling request, a user device may operate as follows:

if (positive SR)

transmit SR only
drop ACK/NACK

else (negative SR)

transmit ACK/NACK only

end

The simultaneous transmission of the other option may be carried out via multiple PUCCH resources. In this case, a user device procedure may be as follows: The user device transmits a scheduling request and ACK/NACK concurrently. This may be carried out when the user device has been configured to support simultaneous transmission of a scheduling request and ACK/NACK (regardless of cubic metric increment). In the case of SU-MIMO, one option is that the user device transmits ACK/NACK using an ACK/NACK resource and one antenna-port and a positive scheduling request using a scheduling request resource and another antenna port.

In other words:

if (positive SR)

transmit SR using SR resource (enhanced format) and

ACK/NACK using ACK/NACK resource
else (negative SR)

transmit ACK/NACK only

end

An eNB procedure could correspondingly be: the eNB configures a user device to support transmission of a positive SR (using enhanced SR resource) and ACK/NACK at the same time using separate resources.

Higher layer signalling may be used to configure a selected option. Accordingly, a higher layer configuration signalling with one additional bit (or two signalling states) may be used to switch between two scheduling request resources having the same PUCCH format 1/1a/1b resource index (in other words, signalling an additional cover code value for enhanced scheduling request transmission).

In block 204, a physical uplink control channel is overbooked by extending scheduling request configuration signalling. This may be achieved for example by using unused PUCCH format 1/1a/1b resources for persistently scheduled ACK/NACK and scheduling request messages. The overbooking may be implemented by extending scheduling request configuration signalling to support denser PUCCH configuration.

The core principle of the overbooking is shown in Tables 2 and 3 below. Required signalling enabling the overbooking may be accomplished for instance by adding one or two additional bits in the existing scheduling request configuration. These bits may be used to convey a cyclic shift offset parameter called as delta_offset. In one embodiment, existing scheduling request resource allocation signalling is maintained the same as originally and the new resources are made proportional to existing resources for instance by means of delta_offset. The cyclic shift for the new PUCCH format 1/1a/1b resources (denoted as Res_1) may be derived as:

Res_{—}1(n)=(Res(n)+delta_offset)mod 12, delta_offsetε[0,1,2], (1)

### Wherein

Res(n)denotes to the cyclic shift coding scheme of existing
n^{th} PUCCH format 1/1a/1b resource (having same resource index), and
mod 12 denotes a modulo arithmetic operation.

In block 206, physical uplink control channel resource is randomized. This may also be combined with the overbooking.

Typically, cyclic shift hopping and PUCCH resource re-mapping (re-mapping usually in this context corresponds to a pre-determined permutation of physical resource blocks-specific resources 0-17 at the slot boundary) are used on PUCCH format 1/1a/1b. Hence, a need for sufficient randomization between two PUCCH Format 1/1a/1b resource groups (Res and Res_1) may exist. This may be achieved by using a “Res_1” randomization scheme, wherein a cell-specific cyclic shift hopping is applied according to Third Generation partnership Project (3GPP) release 8 and/or “Res_1”-specific re-mapping for additional PUCCH resources. The probably simplest approach is not to carry out PUCCH format 1/1a/1b re-mapping for the additional PUCHH resources (Res_1). In another randomizing option, re-mapping according to delta_shift=1 is performed, regardless of the actual delta_shift used. This enables eNB to reserve certain PUCCH physical resource blocks (PRBs) exclusively for LTE-Advanced user devices using a denser PUCCH configuration. This embodiment may be carried out by including one additional bit in a dedicated higher layer scheduling request configuration (that is applying PUCCH re-mapping according to delta_shift=1 instead of original delta_shift).

Randomising between two physical uplink control channel format 1/1a/1b resource groups (Res and Res_1) may be carried out by using a resource group “Res_1” randomization scheme, wherein a cell-specific cyclic shift hopping and/or resource group “Res_1”-specific resource re-mapping or no re-mapping for resource group “Res_1” may be applied, for example.

Table 2 shows resource allocation according to release 8 and table 3 shows resource allocation according to denser resource allocation. In the tables, delta-shift=2.

TABLE 2

| Cyclic | Orthogonal cover | | | |
|---|---|---|---|---|
| shift | 0 | 1 | 2 | 3 |
| 0 | 0 | | 12 | |
| 1 | | 6 | | |
| 2 | 1 | | 13 | |
| 3 | | 7 | | |
| 4 | 2 | | 14 | |
| 5 | | 8 | | |
| 6 | 3 | | 15 | |
| 7 | | 9 | | |
| 8 | 4 | | 16 | |
| 9 | | 10 | | |
| 10 | 5 | | 17 | |
| 11 | | 11 | | |

TABLE 3

| | |
|---|---|
| Cyclic | Orthogonal cover |

| shift | 0 | 1 | 2 | 3 |
|---|---|---|---|---|
| 0 | 0 | 11_1 | 12 | |
| 1 | 0_1 | 6 | 12_1 | |
| 2 | 1 | 6-1 | 13 | |
| 3 | 1_1 | 7 | 13_1 | |
| 4 | 2 | 7_1 | 14 | |
| 5 | 2_1 | 8 | 14_1 | |
| 6 | 3 | 8_1 | 15 | |
| 7 | 3_1 | 9 | 15_1 | |
| 8 | 4 | 9_1 | 16 | |
| 9 | 4-1 | 10 | 16_1 | |
| 10 | 5 | 10_1 | 17 | |
| 11 | 5-1 | 11 | 17_1 | |

Table 4 shows another possibility for realization of overbooked PUCCH resource allocation. In this embodiment, “Res_1” capitalises on an unused orthogonal cover code space of the data part of PUCCH format 1/1a/1b.

TABLE 4

| | | |
|---|---|---|
| Cyclic | Orthogonal cover | unused |

| shift | 0 | 1 | 2 | 3 |
|---|---|---|---|---|
| 0 | 0 | | 12 | 11_1 |
| 1 | 0_1 | 6 | 12_1 | |
| 2 | 1 | | 13 | 6-1 |
| 3 | 1_1 | 7 | 13_1 | |
| 4 | 2 | | 14 | 7_1 |
| 5 | 2_1 | 8 | 14_1 | |
| 6 | 3 | | 15 | 8_1 |
| 7 | 3_1 | 9 | 15_1 | |
| 8 | 4 | | 16 | 9_1 |
| 9 | 4_1 | 10 | 16_1 | |
| 10 | 5 | | 17 | 10_1 |
| 11 | 5_1 | 11 | | |

The embodiment ends in block 208. The embodiment is repeatable in many different ways and arrow 210 shows one example.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. The signaling messages are only put forward as examples and may even comprise several separate messages for transmitting the same information. In addition, the messages may also contain other information.

An embodiment provides an apparatus which may be any user device or any other suitable apparatus able to carry out processes described above in relation to FIG. 2. FIG. 3 illustrates a simplified block diagram of an apparatus according to an embodiment especially suitable for improving scheduling request capacity. It should be appreciated that the apparatus may also include other units or parts than those depicted in FIG. 3. Although the apparatus has been depicted as one entity, different modules and memory may be implemented in one or more physical or logical entities.

The apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as C, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a user device, or a corresponding component, may be configured as a computer or a microprocessor, such as single-chip computer element, or as a chipset, including at least a memory for providing storage capacity used for arithmetic operation and an operation processor for executing the arithmetic operation.

As an example of an apparatus according to an embodiment, it is shown an apparatus, such as a user device or user terminal, including facilities in a control unit 300 (including one or more processors, for example) to carry out functions of embodiments, such as prioritizing and overbooking. This is depicted in FIG. 3.

The apparatus may also include at least one processor 300 and at least one memory 302 including a computer program code, the at least one memory and the computer program code configured to, with the at least one processor, cause the apparatus at least to: prioritize either a positive acknowledgement (ACK) or negative acknowledgement (NACK) transmission or a scheduling request information transmission, or generate a simultaneous transmission of said transmissions for separate resources, and/or overbook a physical uplink control channel by extending scheduling request configuration signalling, and/or randomising a physical uplink control channel resource.

Another example of an apparatus comprises means (304) for prioritizing either a positive acknowledgement (ACK) or negative acknowledgement (NACK) transmission or a scheduling request information transmission, means (306) for generating a simultaneous transmission of said transmissions for separate resources, means (308) for overbooking a physical uplink control channel by extending scheduling request configuration signalling, and/or means (310) for randomising a physical uplink control channel resource. Yet another example of an apparatus comprises a prioritizer configured to prioritize either a positive acknowledgement (ACK) or negative acknowledgement (NACK) transmission or a scheduling request information transmission, a generator configured to generate a simultaneous transmission of said transmissions for separate resources, an overbooker configured to overbook a physical uplink control channel by extending scheduling request configuration signalling, and/or a randomiser configured to randomise a physical uplink control channel resource.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control depending on the implementation, etc. The apparatus may utilize a transmitter and/or receiver which are not included in the apparatus itself, such as a processor, but are available to it, being operably coupled to the apparatus.

An embodiment provides a computer program embodied on a distribution medium, comprising program instructions which, when loaded into an electronic apparatus, constitute the apparatus as explained above.

Another embodiment provides a computer program embodied on a computer readable medium, configured to control a processor to perform embodiments of the method described above.

The computer program may be in source code form, object code form, or in some intermediate form, and it may be stored in some sort of carrier or a distribution medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
prioritize either a positive/negative acknowledgement transmission or a scheduling request information transmission, or generate a simultaneous transmission of said transmissions for separate resources, and/or overbook a physical uplink control channel by extending scheduling request configuration signaling, and/or randomize a physical uplink control channel resource.

2. The apparatus of claim 1, wherein a hybrid automatic repeat request acknowledgement message and a scheduling request using physical uplink control channel format Ia or Ib, and scheduling request message using enhanced scheduling request transmission are made as alternatives to each other in prioritizing.

3. The apparatus according to claim 1, wherein the positive/negative acknowledgement transmission is carried out via physical uplink shared channel and multiplexed with uplink data, and a buffer status report including information on a scheduling request is signaled instead of a scheduling request message.

4. The apparatus according to claim 1, wherein the positive/negative acknowledgement transmission is carried out using a positive/negative acknowledgement message resource and a positive scheduling request information transmission is carried out using a scheduling re-quest resource.

5. The apparatus according to claim 1, wherein the overbooking is carried out by using unused physical uplink control channel format 1/Ia/Ib resources and extending physical uplink control channel format 1/1a/1b configuration signaling to support a denser physical control uplink configuration.

6. The apparatus according to claim 1, wherein randomizing between two physical uplink control channel format 1/Ia/Ib resource groups (Res and Res_1) is carried out by using a resource group “Res_1” randomization scheme, wherein a cell-specific cyclic shift hopping and/or resource group “Res_1”-specific resource re-mapping or no re-mapping for resource group “Res_1” is applied.

7. The apparatus according to claim 1, the apparatus comprising a user device.

8. A computer program comprising program instructions which, when loaded into the apparatus, constitute the modules of claim 1.

9. A method comprising:
prioritizing either a positive/negative acknowledgement transmission or a scheduling request information transmission, or generating a simultaneous transmission of said transmissions for separate resources; and/or
overbooking a physical uplink control channel by extending scheduling request configuration signaling; and/or
randomizing a physical uplink control channel resource.

10. The method of claim 9, wherein a hybrid automatic repeat request acknowledgement message and a scheduling re-quest using physical uplink control channel format 1a or 1b, and scheduling request message using enhanced scheduling request transmission are made as alternatives to each other in prioritizing.

11. The method according to claim 9, wherein the positive/negative acknowledgement transmission is carried out via physical uplink shared channel and multiplexed with uplink data, and a buffer status report including information on a scheduling request is signaled instead of a scheduling request message.

12. The method according to claim 9, wherein the positive/negative acknowledgement transmission is carried out using a positive/negative acknowledgement message resource and a positive scheduling request information transmission is carried out using a scheduling request resource.

13. The method according to claim 9, wherein the overbooking is carried out by using unused physical uplink control channel format 1/1a/1b resources and extending physical uplink control channel format 1/1a/1b configuration signaling to support a denser physical control uplink configuration.

14. The method according to claim 9, wherein randomizing between two physical uplink control channel format 1/1a/1b resource groups (Res and Res_1) is carried out by using a resource group “Res_1” randomization scheme, wherein a cell-specific cyclic shift hopping and/or resource group “Res_1”-specific resource re-mapping or no re-mapping for resource group “Res_1” is applied.

15. An apparatus comprising:
means for prioritizing either a positive/negative acknowledgement transmission or a scheduling request information transmission, or generating a simultaneous transmission of said transmissions for separate resources; and/or
means for overbooking a physical uplink control channel by extending scheduling request configuration signaling; and/or
means for randomizing a physical uplink control channel resource.

16. A computer program product embodied on a computer readable medium, the computer program being configured to control a processor to perform:
prioritizing either a positive/negative acknowledgement transmission or a scheduling request information transmission, or generating a simultaneous transmission of said transmissions for separate resources; and/or
overbooking a physical uplink control channel by extending scheduling request configuration signaling; and/or
randomizing a physical uplink control channel resource.

17. The computer program product of claim 16, wherein a hybrid automatic repeat request acknowledgement message and a scheduling request using physical uplink control channel format 1a or 1b, and scheduling request message using enhanced scheduling request transmission are made as alternatives to each other in prioritizing.

18. The computer program product according to claim 16, wherein the positive/negative acknowledgement transmission is carried out via physical uplink shared channel and multiplexed with uplink data, and a buffer status report including information on a scheduling request is signaled instead of a scheduling request message.

19. The computer program product according to claim 16, wherein the positive/negative acknowledgement transmission is carried out using a positive or negative acknowledgement message resource and a positive scheduling request information transmission is carried out using a scheduling request resource.

20. The computer program product according to claim 16, wherein the overbooking is carried out by using unused physical uplink control channel format 1/1a/1b resources and extending physical uplink control channel format 1/1a/1b configuration signaling to support a denser physical control uplink configuration.

21. The computer program product according to claim 16, wherein randomizing between two physical uplink control channel format 1/1a/1b resource groups (Res and Res_1) is carried out by using a resource group “Res_1” randomization scheme, wherein a cell-specific cyclic shift hopping and/or resource group “Res_1”-specific resource re-mapping or no re-mapping for resource group “Res_1” is applied.

22. A computer-readable medium encoded with instructions that, when executed by a computer, perform:
prioritizing either a positive/negative acknowledgement transmission or a scheduling request information transmission, or generating a simultaneous transmission of said transmissions for separate resources; and/or
overbooking a physical uplink control channel by extending scheduling request configuration signaling; and/or
randomizing a physical uplink control channel resource.
